(19) United States
(12) Patent Application Publication
(10) Pub. No.: US 2009/0209886 A1
(43) Pub. Date: Aug. 20, 2009

(54) Device for Treating, in Particular Massaging, the Connective Tissue of the Skin

(75) Inventor: Gianfranco Tudico, Bourg-Les-Valence (FR)

Correspondence Address: ADVANTEDGE LAW GROUP, LLC, 922 W. BAXTER DRIVE, SUITE 100, SOUTH JORDAN, UT, 84095, US

(73) Assignee: Louisin Research and Development Limited - chez John Behan & Company, Dublin (IE)

(21) Appl. No.: 12/305,593

(22) PCT Filed: Jun. 21, 2007
(86) PCT No.: PCT/FR2007/001029

§ 371 Date: Feb. 18, 2009

(30) Foreign Application Priority Data
Jun. 22, 2006 (FR) 06 05596

(51) Int. Cl. A61H 7/00

(52) U.S. Cl. 601/6; 601/133

(57) ABSTRACT

This device (1) comprises, on the one hand, a casing (10) defining a treatment chamber (40) which opens onto the skin and is designed to be connected to a vacuum source and, on the other hand, elements (24₁ and 24₂) which work the skin and which are mounted movably in the casing with sliding contact against associated walls (28₁, 28₂) of the casing. To pinch the skin reliably and effectively, while allowing the device to be moved easily and with precision along areas of skin that are awkward to treat, such as highly curved areas, each working element is displaceable relative to the casing both in rotation (R) on itself about a central axis (Z₁-Z₁, Z₂-Z₂) of the element and also in translation (T) along this axis against the associated wall.

The present invention relates to a device for treating, in particular massaging, the connective tissue of the skin of a subject, associated with a vacuum source.

The invention relates in particular to the devices used to treat the connective tissue of cutaneous areas of the human body that are difficult to access because they are adjacent to other areas of the body and/or are highly curved, such as the face, the joints, the fingers, etc. In these areas, the aim is generally to work the skin by locally alternating pinching and relaxing of the connective tissue.

Conventionally, these areas that are awkward to work are massaged by hand, by the fingertips of a masseur, which, in the long term, tires the latter. Furthermore, the massage treatments performed in this way are not very uniform, since they depend on the level of the stresses exerted by the masseur, and on the state of tiredness of the latter.

To overcome these drawbacks, FR-A-2 752 159 has proposed a massage device, which can be actuated manually and makes it possible, by associating it with a pulsed vacuum source, to alternately pinch and relax a fold of skin. To do this, the device defines a treatment chamber which is connected to the vacuum source and in which a partition is, in the top part, mounted to pivot about a physical axis. In service, under the effect of the depression inside the treatment chamber, this partition pinches the skin against a fixed wall of the casing. It will be understood that this device is satisfactory only if it remains immobile: immediately it is displaced, the bottom edge of the partition rubs, may even jam, against the skin of the subject, which makes the device difficult to maneuver reliably and precisely. Furthermore, a good seal between the skin and the partition becomes awkward to maintain, which renders the treatment largely ineffective, except by increasing the vacuum level inside the treatment chamber. However, in this case, the difficulties in displacing the device are accentuated and the fold of skin is pinched with such an intensity that the massage soon becomes painful to the subject, even incompatible with cutaneous areas that are highly curved and/or with certain skin types, for example brittle, damaged or scarred skin.

In the field of massage devices that make it possible to perform particular massages of the “pin and roll” type, FR-A-2 768 051 has proposed closing the open ends of a suction chamber, which extends transversely over the entire width of the casing of the device, by rotating disks that bear in a sealed manner against extreme lateral walls of the casing. The handlability of the device against the skin is in principle enhanced, inasmuch as each disk can roll on the skin while limiting the friction of the device. However, because of the fact that they bear in a sealed manner against the lateral walls of the casing, these disks are necessarily immobile in the direction of the width of the casing, so that they can neither converge nor move away from each other, preventing the skin from being pinched then relaxed to be effectively treated, as explained above. FR-A-2 768 051 proposes adding inside the suction chamber transverse rollers, that is rollers that extend widthwise in the casing, between the lateral disks, it being noted that these rollers are specified as falling within the scope in particular of EP-A-0 224 422. In these conditions, the rolling lateral rests of the disks are then combined with a “pinch and roll” massage, that is, over the entire length of these rollers, the skin is folded in a direction perpendicular to the axis of rotation of the lateral disks. This cutaneous treatment requires very high vacuum levels in the chamber and is incompatible with highly curved cutaneous areas and/or for certain types of skin, as explained above.

The aim of the present invention is to overcome the drawbacks stated above, by proposing an innovative and beneficial treatment device, which acts by pinching on the skin of a subject in a reliable and effective manner, while being easy and accurate to displace, in particular against areas of skin that are awkward to treat, such as the face, the joints, scarred areas, etc.

To this end, the subject of the invention is a device for treating, in particular massaging, the connective tissue of the skin of a subject, associated with a vacuum source, as defined in claim 1.

Thus, the or each working element of the device according to the invention combines a dual movement capability relative to one and the same axis of displacement. By rotating on itself about this axis, the working element can roll against the skin, which makes its displacement particularly easy. The device can thus accurately follow intricate treatment lines, for example S-shaped lines. Furthermore, by being able to be displaced in translation along the above-mentioned axis, the working element can pinch the skin in a direction that is overall parallel to this axis. In service, the translation movements of the working element are controlled by the depression inside the treatment chamber: since this element is translated against the wall of the casing that delimits, together with the element, the treatment chamber, the latter is effectively sealed, which allows for an effective pinching of the skin, without the use of excessive vacuum levels in the chamber. The combination of the rotary and translational capabilities of the or each working element makes the device according to the invention particularly effective and handleable, both for an entrainment of the device in 360° rotation in situ, and for displacement of this device along straight or incurved, for example S-shaped, treatment lines without differential effect. It will be understood that the device according to the invention is particularly well suited to the highly curved cutaneous areas, such as the face or the joints of the subject, and for certain types of fragile skin, for example damaged or scarred skin.

The device offers a reliable structure that can be constructed in different sizes, by homothetic translation of the dimensions of the casing and of the working element or elements. It is thus possible to have a range of devices of different sizes, it being noted that, in the extreme, very small devices can be proposed. In particular, the treatment chamber does not have to extend from one side of the casing to the other, but, on the contrary, offers a free choice of volume. In all cases, the “casing/working element(s)” structure is compact and lightweight, which reinforces the handlability of the device and which makes it possible to apply the working elements to areas of the human body that are difficult to access.

By providing for the or each working element to be made of lightweight material, such as a plastic material, the inertia of this element is negligible with respect to pressure variations inside the treatment chamber. This control of these pressure variations thus directly determines the action on the connective tissue. The skin can in particular be alternately pinched and relaxed with a precise frequency, which causes the connective tissue to be tightened up again and the collagen fibers to be stimulated in a controlled way.

With high frequencies, the skin undergoes a particularly effective dynamic stimulation.

Other features of the treatment device, taken in isolation or in all the technically possible combinations, are stated in the dependent claims 2 to 14.

The invention will be better understood from reading the description that follows, given purely as an example and with reference to the drawings in which:

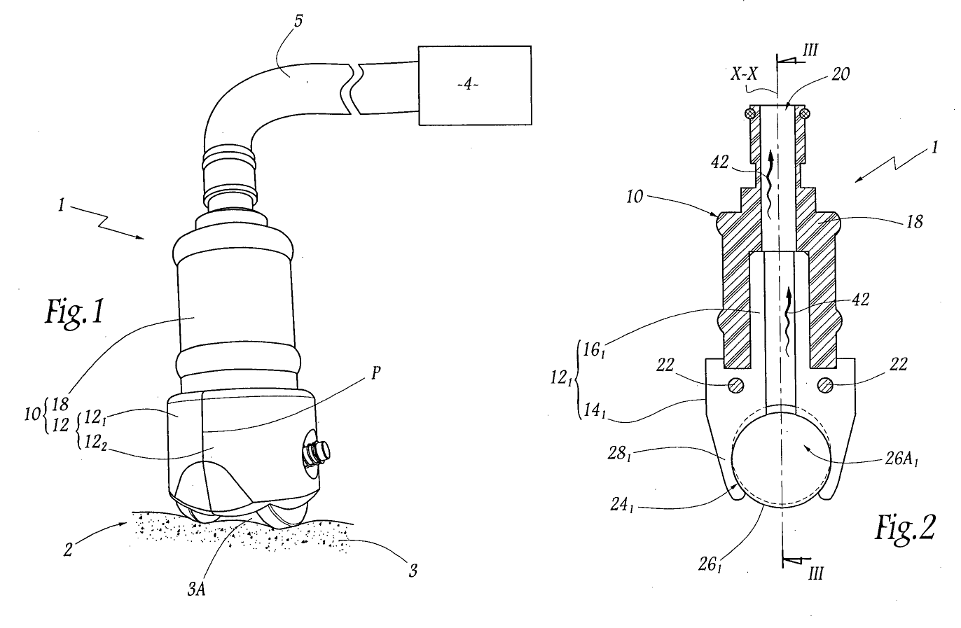

FIG. 1 is a perspective diagrammatic view of a device according to the invention, applied to a subject;

FIG. 2 is a longitudinal cross-section of the device of FIG. 1;

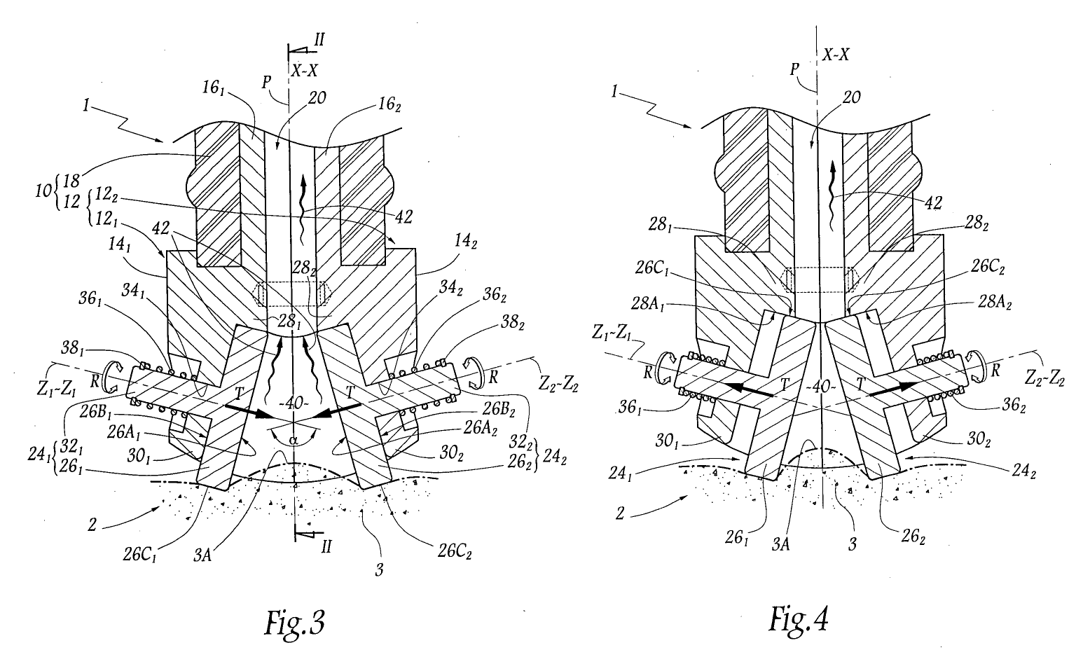

FIG. 3 is a partial longitudinal cross-section, taken along the line III-III of FIG. 2, it being noted that the line II-II indicated in FIG. 3 corresponds to the plane of cross-section of FIG. 2;

FIG. 4 is a partial cross-section similar to FIG. 3, illustrating the device in an operating configuration that is different from that of FIG. 3;

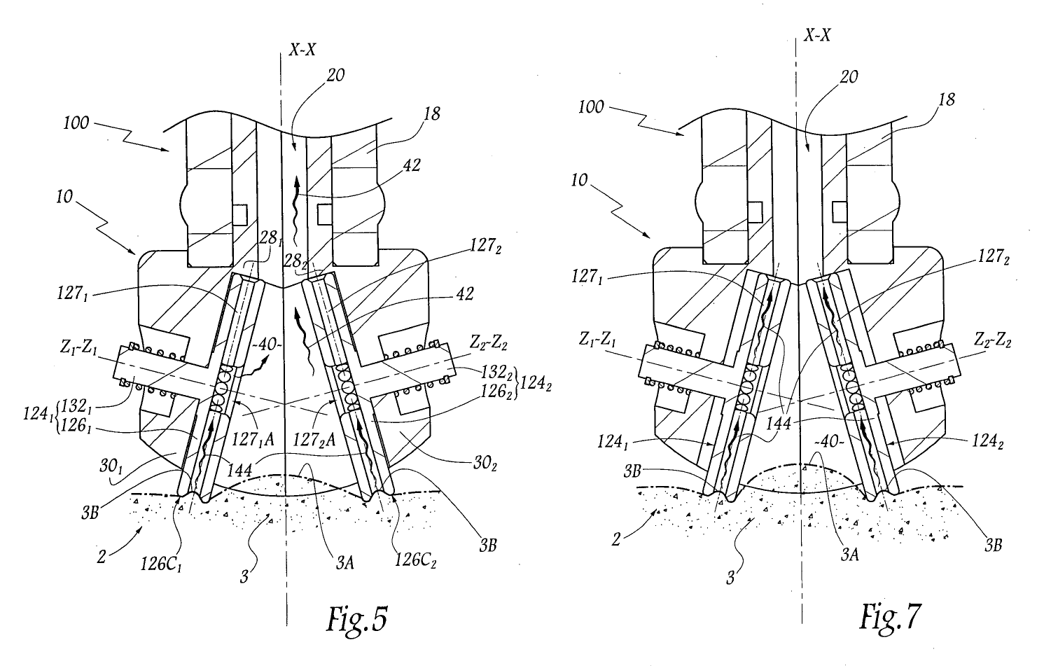

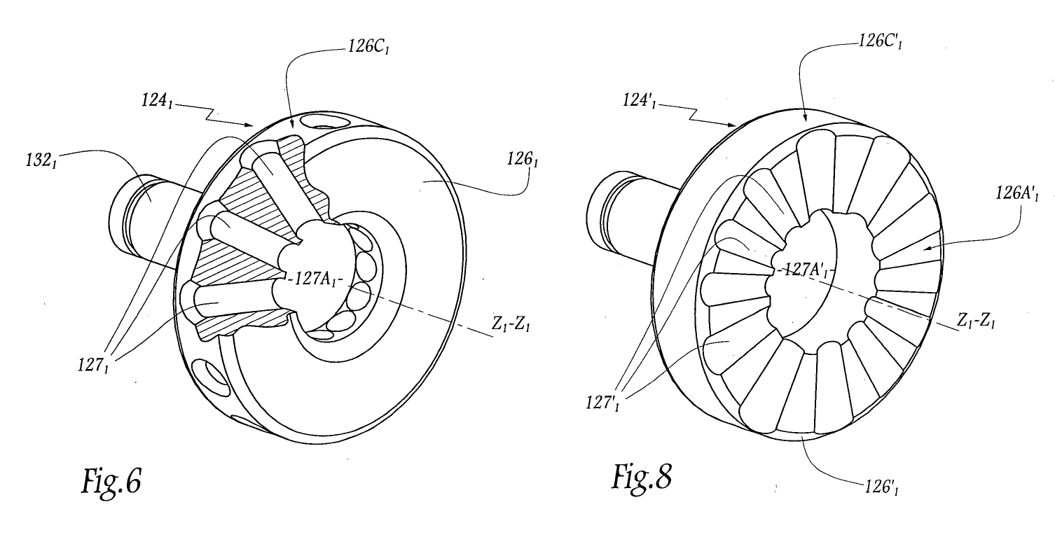

FIGS. 5 to 7 illustrate a variant of the device according to the invention, FIGS. 5 and 7 respectively being views similar to FIGS. 3 and 4 whereas FIG. 6 is a perspective view, with partial cut-away, of one of the skin-working elements according to this variant;

FIG. 8 is a view similar to FIG. 6, illustrating another embodiment variant for the working elements; and

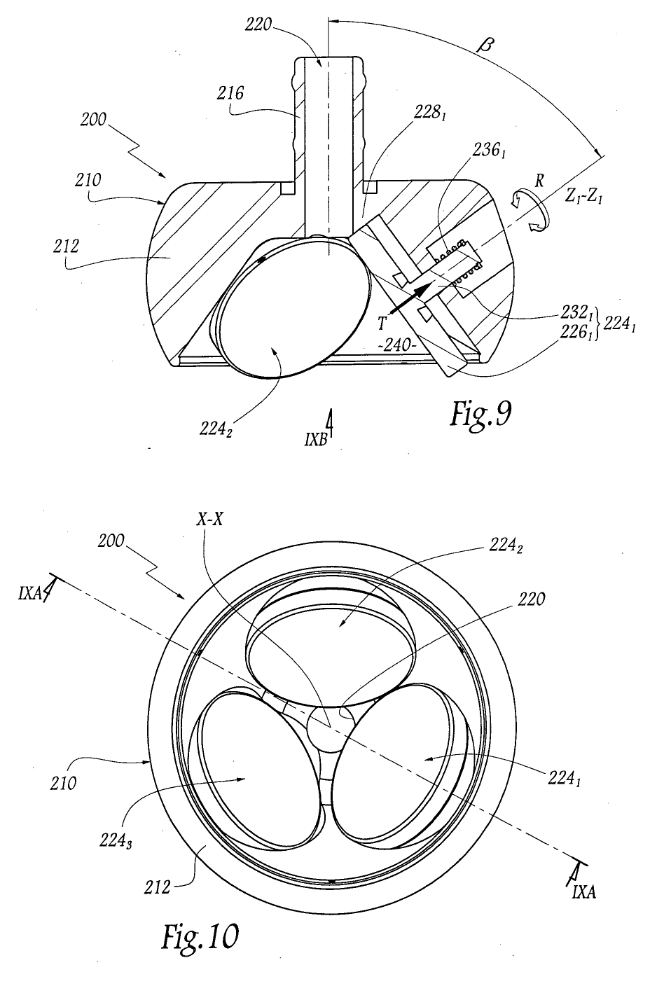

FIGS. 9 and 10 illustrate yet another variant of the device according to the invention, FIG. 9 being a cross-section along the line IXA-IXA indicated in FIG. 10 whereas FIG. 10 is an elevation view according to the arrow IXB indicated in FIG. 9.

FIGS. 1 to 4 represent a massage device 1 that makes it possible to alternately pinch and relax the connective tissue of the skin 3 of a subject 2, as detailed below in the description of the operation of the device.

For convenience, the rest of the description is based on the assumption that the device 1 rests on the subject 2, so that the terms “bottom” and “down” designate a direction directed toward the skin 3 of the subject, whereas the terms “top” and “up” correspond to an opposite direction.

The device 1 comprises a rigid casing 10, made, in whole or in part, of metal, of plastic material, etc. This casing has an overall elongate shape and extends about a central axis X-X.

In its bottom part, the casing 10 comprises a main body 12 of overall tubular shape centered on the axis X-X. In this case, according to an embodiment that is compact and easy to build, the body 12 comprises two identical parts 12₁ and 12₂, fixedly joined to each other symmetrically relative to a median plane P containing the axis X-X and corresponding to the plane of cross-section of FIG. 2. Each part 12₁, 12₂ comprises a semi-tubular bottom base 14₁, 14₂, from which extends upward a semi-cylindrical top nozzle 16₁, 16₂. When the parts 12₁ and 12₂ are joined to each other either side of the plane P, the nozzles 16₁ and 16₂ together form a chimney centered on the axis X-X, about which is added a top joining head 18, for example force-fitted into an annular groove delimited in the junction areas between the bases 14₁ and 14₂ and the nozzles 16₁ and 16₂.

The casing 10 is designed to be connected to a vacuum source 4, such as a vacuum pump, a depressurized network, a suction motor, etc. To this end, the head 18 forms, at its top end, a flange for connecting to the vacuum source 4, for example via a hose 5, whereas, internally, this head and the chimney 16 vertically delimit a duct 20 centered on the axis X-X open at its top end and opening out at its bottom end inside a free volume delimited internally by the bases 14₁ and 14₂.

The joining of the body parts 12₁ and 12₂ is optionally reinforced by pins 22, each of which is, partly, received fixedly in respective holes delimited, symmetrically relative to the plane P, in the junction area between the nozzle 16₁, 16₂ and the base 14₁, 14₂ of each part 12₁, 12₂.

Each body part 12₁, 12₂ is provided, at the level of its base 14₁, 14₂, with an element 24₁, 24₂ that works the skin 3. For convenience, the element 24₁ is described hereinbelow in detail, it being noted that the other element 24₂ has similar arrangements, symmetrical relative to the plane P to the corresponding arrangements of the element 24₁ and bearing the same numerical references followed by the index 2 instead of the index 1.

The working element 24₁ essentially comprises a full disk 26₁, defining a central axis Z₁-Z₁. This disk is received inside the base 14₁, with its axis Z₁-Z₁ extending transversely to the axis X-X, in a plane perpendicular to the plane P, corresponding to the plane of FIGS. 3 and 4. The axis Z₁-Z₁ is inclined downward toward the plane P moving away from the element 24₁. Thus, the disk 26₁ presents a flat face 26A₁ directed toward the plane P, an opposite flat face 26B₁, and a cylindrical peripheral surface 26C₁ connecting the faces 26A₁ and 26B₁.

The element 24₁ is mounted movably in the base 14₁ so that the disk 26₁ cooperates with a wall 28₁ of the base 14₁, which extends from the plane P to a lateral end wall 30₁ of the base. This current wall 28₁ delimits a semi-cylindrical internal surface 28A₁ with circular base, centered on the axis Z₁-Z₁ and on the top end of which opens out the bottom end of the duct 20. The diameter of the transverse cross-section of this surface 28A₁ is substantially equal to the external diameter of the disk 26₁, so that the surfaces 28A₁ and 26C₁ are substantially fitted to each other, discounting any functional plays. The semi-circular shape of the surface 28A₁ is closed over more than 180°, while being open downward, so that the lowest portion of the disk 26₁ extends downward beyond the bottom end edge of the wall 28₁, as can be seen in the figures.

Furthermore, the working element 24₁ is provided with a rod 32₁, centered on the axis Z₁-Z₁ and extending projecting outward from the face 26B₁ of the disk 26₁. Here, the rod 32₁ and the disk 26₁ are made in one single part. This rod is received in a hole 34₁ that is substantially complementary and that passes through the lateral end wall 30₁ along the axis Z₁-Z₁.

From a kinematic point of view, the working element 24₁ can be displaced relative to the base 14₁ of the casing 10 by two independent movements, namely a free rotation movement about the axis Z₁-Z₁, indicated by the arrow R in the figures, and a straight translational movement along the same axis, indicated by the arrow T in the figures. These two movements are guided by cooperation, on the one hand, of the surfaces 26C₁ and 28A₁ at the level of the current wall 28₁ and, on the other hand, of the peripheral surface of the rod 32₁ and of the peripheral wall delimiting the hole 34₁ at the level of the end wall 30₁.

The rotary movements of the working element 24₁ are free, in the sense that its entrainment is not constrained by any element of the device 1. The translational movements T of this element are, however, influenced by a compression spring 36₁ positioned between the rod 32₁ and the wall 30₁. More specifically, this spring is arranged around a part of the rod positioned outside the wall 30₁, opposite the wall 28₁, while being pressed to bear against, on the one hand, the wall 30₁ and, on the other hand, a ring 38₁ added fixedly to the free end of the rod 32₁. Under the effect of the spring 36₁, the working element 24₁ tends normally to move away from the plane P along the axis Z₁-Z₁, until the disk 26₁ abuts against the wall 30₁, pressing the face 26B₁ against the opposite face of this wall, as in FIG. 3.

In the assembled state of the device 1, the casing 10 internally defines a treatment chamber 40 delimited both by the disks 26₁ and 26₂ and by the walls 28₁ and 28₂. This chamber is thus opened downward, between the bottom portions of the disks, whereas it is sealed around the rest of the periphery of the disks, thanks to the tight fit between the surfaces 26C₁ and 26C₂ of the disks and the surfaces 28A₁ and 28A₂ of the walls 28₁ and 28₂, except at the level of the bottom end of the duct 20, which thus opens out into the chamber 40.

The massage device 1 is used as follows:

The casing 10 is manipulated so that the bottom portions of the disks 26₁ and 26₂ are applied against the skin 3 of the subject 2, as represented in FIG. 1. The treatment chamber 40 is then opened directly onto the skin 3, as represented in FIGS. 3 and 4. By actuating the vacuum source 4, the air contained in the chamber 40 is sucked out through the duct 20, as indicated by the undulating arrows 42, so as to create a depression inside the chamber. Under the effect of this depression, the skin is sucked between the disks 26₁ and 26₂, forming a fold of skin 3A, and the working elements 24₁ and 24₂ are translated one toward the other, respectively along their axis Z₁-Z₁ and Z₂-Z₂. These elements 24₁ and 24₂ then pass from a rest position, represented in FIG. 3, in which they are respectively pressed against the walls 30₁ and 30₂ under the action of the springs 36₁ and 36₂, to a position close to one another, represented in FIG. 4, in which the fold of skin 3A is pinched between the faces 26A₁ and 26A₂ of the disks 26₁ and 26₂.

Advantageously, in their close position of FIG. 4, the top portions of the disks 26₁ and 26₂ lock, at least partially, the opening of the duct 20 into the treatment chamber 40, their peripheral surface 26C₁ and 26C₂ then extending through this opening. The action of the vacuum source 4 is then significantly lessened, even interrupted, inasmuch as the outside air seeps through at the level of the bottom end edges of the walls 28₁ and 28₂, 30₁ and 30₂ inside the chamber, with a sufficient flow rate to repressurize the chamber. The springs 36₁ and 36₂ then return the working elements 24₁ and 24₂ in translation to their rest position of FIG. 3, thus relaxing the fold of skin 3A. The opening of the duct 20 into the chamber is freed, making it possible to create a new depression inside the chamber, and so on.

Blocking the suction duct 20 by the working elements 24₁ and 24₂ renders the device safe, inasmuch as an excessive vacuum level cannot be reached inside the treatment chamber 40. Furthermore, this way, the vacuum source 4 can be based on a simple technology, inasmuch as this vacuum source does not have to be controlled in a pulsed or jerky manner to generate the reciprocating translational movements of the working elements.

Thus, it will be understood that the elements 24₁ and 24₂ are translated along the axes Z₁-Z₁ and Z₂-Z₂ by straight beat movements, alternately causing the sucked fold of skin 3A to be pinched and relaxed.

Independently of the translational movements of the elements 24₁ and 24₂, the casing 10 can be entrained along the skin 3 of the subject 2, by rotating these elements on themselves respectively about axes Z₁-Z₁ and Z₂-Z₂. The peripheral surfaces 26C₁ and 26C₂ of the disks 26₁ and 26₂ then roll easily, that is without significant effort, against the skin, at the level of their bottom portion, the direction of rotation of the elements being unimportant. The casing 10 can also be entrained in rotation on itself about its central axis X-X; in this case, one of the working elements revolves clockwise, whereas the other element revolves anti-clockwise.

Both during the translation movements T and during the rotation movements R of the working elements 24₁ and 24₂, the sealing of the treatment chamber 40 along the periphery of the disks 26₁ and 26₂ is overall maintained by sliding contact of the peripheral surfaces 26C₁ and 26C₂ against the tight-fitted surfaces 28A₁ and 28A₂ of the casing walls 28₁ and 28₂. Thus, no additional sealing piece needs to be added to the casing 10.

It will be understood that each working element 24₁, 24₂ can be likened, in operation, to a piston that can be displaced in translation inside an associated housing delimited by the semi-cylindrical wall 28₁, 28₂, while enabling this piston to be able to revolve freely on itself about the axis along which it is translated. This form of piston offers the advantage of combining effectiveness, lightness and simplicity, in particular compared to sophisticated moving structures which, because of their complexity, are heavy and less effective.

The inclination of the axes Z₁-Z₁ and Z₂-Z₂ relative to the plane P allows for a better grasp of the fold of skin 3A in its pinching, without in any way hampering the rolling of the disks, or creating excess cutaneous stresses which could prove painful to the subject 2. To this end, the axes Z₁-Z₁ and Z₂-Z₂, which converge toward one another in the direction of the open side of the treatment chamber 40 when the working elements 24₁ and 24₂ move apart, form between them an angle α of 150°±10°.

Moreover, the embodiment of the casing body 12 in two assembled parts 12₁ and 12₂ presents the advantage of providing a casing that can be easily and quickly dismantled, which simplifies the cleaning of the device, in particular of the treatment chamber 40.

FIGS. 5 to 7 represent a massage device 100 which constitutes a variant of the device 1 and which is distinguished from the latter only by these elements 124₁ and 124₂ that work the skin 3. The other components of the devices 1 and 100 are identical, so these components of the device 100 are identified hereinbelow and in the figures by the same references as those used for the device 1.

Unlike the disks 26₁ and 26₂ with solid structure, each working element 124₁, 124₂ essentially comprises a perforated disk 126₁, 126₂. More specifically, each disk 1261, 1262 delimits, in its thickness, passages 127₁, 127₂ that each extend in a direction radial to the central axis Z₁-Z₁, Z₂-Z₂ of the disk. As can be seen in FIG. 6 for the element 124₁, the passages 127₁, 127₂ are distributed uniformly about the axis Z₁-Z₁, Z₂-Z₂, opening out at their end opposite to this axis, on the peripheral face 126C₁, 126C₂ of the disk and opening out, at their end facing the axis Z₁-Z₁, Z₂-Z₂, into a discoidal free volume 127A₁, 127A₂ centered on this axis and in free fluidic communication with the chamber 40.

The external overall shape of the disks 126₁ and 126₂ is identical to that of the disks 26₁ and 26₂, so that, in service, the disks 126₁ and 126₂ cooperate with the walls 28₁ and 30₁, 28₂ and 30₂, as described above in detail for the device 1. Similarly, each working element 124₁, 124₂ comprises a rod 132₁, 132₂ identical to the rod 32₁, 32₂ as described above.

The kinematic capabilities of the working elements 124₁ and 124₂ are identical to those of the elements 24₁ and 24₂ relative to the casing 10. The notable difference in operation between the devices 1 and 100 is associated with the presence of the passages 127₁ and 127₂ which enable the vacuum present in the chamber 40 to circulate through the disks 126₁ and 126₂. In this way, at the level of the openings on the outside of the passages 127₁ and 127₂ in contact with the skin 3 of the subject 2, this skin is locally sucked, forming small folds 3B, as represented in FIGS. 5 and 7. The circulation of the vacuum through the disks 126₁ and 126₂ is indicated by the undulating arrows 144, it being noted that, on the one hand, in the rest position of the disks illustrated in FIG. 5, the vacuum circulates from the passages 127₁ and 127₂ opening out onto the skin 3 successively through the volumes 127A₁ and 127A₂, the chamber 40 and the duct 20, whereas, on the other hand, when the disks are in their position close to one another, represented in FIG. 7, the vacuum circulates from the same passages mainly through the volumes 127A₁ and 127A₂ and the passages 127₁ and 127₂ that are diametrically opposite to the passage opening out onto the skin and that open out themselves directly into the duct 20.

Thus, the benefit of the variant of device 100 consists in stressing the skin 3 both between the working elements 124₁ and 124₂, as for the device 1, and at the level of the peripheral portion of the disks 126₁ and 126₂ rolling against the skin. The connective tissue of the skin is additionally stimulated.

Another benefit of the variant of device 100 is being able to house in one and/or the other of the central volumes 127A₁ and 127A₂ a capsule, not represented, filled with an active substance, such as a cosmetic product. When the device 100 is operating, this capsule is designed to be pressed by the fold of skin 3A, so that the substance that it contains then feeds the passages 127₁ and 127₂ from the central volumes 127A₁ and 127A₂ as far as the peripheral openings of these passages, in particular those in contact with the skin 3. To avoid the active substance being sucked into the duct 20 via the passages 127₁, 127₂ opposite to those opening out onto the skin, the abovementioned passages are substantially blocked by the wall 28₁, 28₂ over the entire translational travel of the working elements 124₁, 124₂, giving, for example, an appropriate dimension, not represented, of the disks 126₁, 126₂ and/or of the walls 28₁, 28₂.

FIG. 8 illustrates an embodiment variant for the working elements of the device 1 or 100, just one of these elements, referenced 124′₁, being represented, it being understood that this device variant is equipped with two of these elements. The element 124′₁ is distinguished from the element 124₁ only by the positioning of the passages 127₁: instead of forming these passages in the thickness of the disk 126₁, the face 126A′₁ of the disk 126′, facing the chamber 40, is hollowed out with radial grooves 127′₁. These grooves are distributed uniformly about the axis Z₁-Z₁, opening out, at their end opposite to this axis, onto the peripheral face 126C′₁ of the disk and opening out, at their end facing toward the axis, into a discoidal free volume 127A′₁ centered on this axis and in free fluidic communication with the chamber 40. This volume 127A′₁ is geometrically similar to the volume 127A₁ of the element 124₁. Advantageously, each groove has a transverse section that increases as the distance from the axis Z₁-Z₁ increases.

With this arrangement of the face 126A′₁, when the disk 126A′ is in service and rhythmically stretches the cells of the “stratum cornum”, which can be likened to tiles, the openings of the grooves 127A′₁ onto the face 126C′₁ stress the skin tangentially and create a play in the intercellular spaces, called micropores. It is then possible to spread active substances into the epidermal layers, and stimulate the collagenic densification by transduction, under biomechanical stimulation.

FIGS. 9 and 10 represent a massage device 200 that constitutes another variant of the device 1. The device 200 is essentially distinguished from the device 1 by the fact that it includes three elements 224₁, 224₂ and 224₃ that work the skin, instead of two.

In the exemplary embodiment considered in FIGS. 9 and 10, the device 200 comprises a one-piece casing 210 extending about a central axis X-X. In its bottom part, the casing 210 forms a tubular body 212, which is centered on the axis X-X and in which are housed the three working elements 224₁, 224₂ and 224₃. In its top part, the casing 210 comprises a nozzle 216 which internally delimits a duct 220 centered on the axis X-X. This duct is, on one side, designed to be connected to the vacuum source 4, via, for example, the hose 5, whereas on the opposite side, it opens out into the free volume of the body 212.

Each working element 224₁, 224₂, 224₃ has a structure identical to that of the elements 24₁ and 24₂ and thus comprises a disk 226₁, 226₂, 226₃ and a rod that are respectively identical to the disks 26₁, 26₂ and to the rods 32₁, 32₂ (only the rod 232₁ of the element 224₁ can be seen in the figures). On the other hand, unlike the elements 24₁ and 24₂ that face one another symmetrically relative to the plane P, the elements 124₁, 124₂ and 124₃ are distributed about the axis X-X, uniformly, as can be clearly seen in FIG. 10. As can be clearly seen in FIG. 9 for the element 224₁, each of these three working elements has kinematic capabilities identical to those of the working elements of the device 1, that is, for example for the element 224₁, the latter can be displaced, both in rotation R on itself about its central axis Z₁-Z₁ and in translation T along this axis, by cooperating by sliding contact with an associated wall 228₁ of the casing 210, the geometry of which is identical to the wall 28₁ of the casing 10. It will be noted that, in FIGS. 9 and 10, the elements 224₁ and 224₂ are represented in their position close to one another, whereas the element 224₃ is represented in its rest position, only for the purposes of illustration, it being understood that this relative configuration of the three working elements has no functional reality: in operation, the three elements 224₁, 224₂ and 224₃ pass simultaneously from their rest position to their close position, under the effect of a depression inside the treatment chamber 240 delimited between them, whereas the elements are returned to their rest position under the action of respective springs similar to the springs 36₁ and 36₂ (only the spring 236₁ associated with the element 224₁ can be seen in FIG. 9).

To effectively grasp a fold of skin when it is being pinched by the elements 224₁, 224₂ and 224₃, without it any way hampering the rolling of the disks 226₁, 226₂ and 226₃ or creating excessive cutaneous stresses that could prove painful to the subject, the central axes of the elements converge toward one another in the direction of the open side of the treatment chamber 240 when the working elements are moved apart. Advantageously, in the plane containing the axis X-X and one of the central axes of these working elements, the angle β formed between these two axes is 55°±5°, as represented in the plane of FIG. 9 which contains the axis X-X and the central axis Z₁-Z₁ of the element 224₁.

Various arrangements and variants to the massage devices 1, 100 and 200 described hereinabove can moreover be envisaged. By way of examples:
instead of providing for the axes Z₁-Z₁ and Z₂-Z₂ to be inclined relative to the plane P, these axes can be substantially aligned, the disks 26₁ and 26₂ then being substantially parallel to one another; in the case of a device with three working elements or more, their respective axes then belong to one and the same plane, in particular perpendicular to the axis X-X;
working elements similar to the elements 124₁ or 124′₁ can be arranged in triplicate, by replacing the elements 224₁, 224₂ and 224₃ in the device 200; and/or
in particular to have a massage device that is even more compact than the device 1 or 100, it is possible to envisage providing only a single working element; for example, according to this variant, the device comprises, on one side of the plane P, the element 24₁, 124₁ or 124′₁ and, on the other side of this plane, a fixed wall incorporated in the casing 10.

1. A device for treating, in particular massaging, the connective tissue of the skin of a subject, associated with a vacuum source, comprising, on the one hand, a casing defining a treatment chamber which opens on the skin and is designed to be connected, via the casing, to the vacuum source and, on the other hand, at least one working element which works the skin, mounted movably in the casing in sliding contact against an associated wall of the casing, this working element and this wall at least partially delimiting the treatment chamber,
wherein the at least one working element can be displaced relative to the casing, both in rotation on itself about a central axis of the working element and in translation along this axis against the associated wall.

2. The device as claimed in claim 1, wherein the at least one working element globally has a discoidal shape centered on the axis.

3. The device as claimed in claim 1, wherein at least two working elements are provided, and wherein the respective axes of these working elements converge toward each other toward the open side of the treatment chamber.

4. The device as claimed in claim 3, wherein two working elements are provided, and wherein the respective axes of these working elements form an angle of 150°±10°.

5. The device as claimed in claim 3, wherein three working elements are provided, and wherein the angle formed between each axis of these working elements and an axis about which these three working elements are distributed, is 55°±5°.

6. The device as claimed in claim 1, wherein at least two working elements are provided, the respective axes of these working elements being either substantially aligned if there are two of these working elements or substantially arranged in one and the same plane if there are three or more of these working elements.

7. The device as claimed in claim 1, wherein the at least one working element is mounted in the casing with free rotation about its axis.

8. The device as claimed in claim 1, wherein the at least one working element can be displaced in translation between a rest position and a pinching position for pinching the skin, the at least one working element being displaced to its pinching position under the effect of a depression inside the treatment chamber, whereas it is displaced to its rest position under the effect of return means incorporated in the device.

9. The device as claimed in claim 8, wherein the casing delimits a duct adapted to be connected to the vacuum source and opening out into the treatment chamber, and wherein the opening of this duct into the treatment chamber is at least partially blocked when the at least one working element is in its pinching position.

10. The device as claimed in claim 1, wherein the associated wall of the casing delimits a semi-cylindrical surface which is centered on the axis of the corresponding working element and which, in transverse cross-section, is substantially fitted to the peripheral surface of this working element.

11. The device as claimed in claim 1, wherein the casing includes parts that are substantially identical, that are joined fixedly to one another and that respectively bear one of the working elements.

12. The device as claimed in claim 1, wherein the at least one working element delimits, in its thickness, passages transversal to the axis of the working element, whereas, alongside this axis, suction passages open out into a free volume delimited by the working element and communicating freely with the treatment chamber.

13. The device as claimed in claim 1, wherein the at least one working element delimits, on its face turned toward the treatment chamber, grooves transversal to the axis of the working element and opening out, opposite this axis, onto the peripheral surface of the working element, whereas, alongside this axis, the suction passages open out into a free volume delimited by the working element and communicating freely with the treatment chamber.

14. The device as claimed in claim 12, wherein a capsule containing an active substance is arranged in the free volume to be pressed by a fold of skin formed in the treatment chamber and to then feed the passages with active substance via their opening into this free volume.

15. The device as claimed in claim 13, wherein a capsule containing an active substance is arranged in the free volume to be pressed by a fold of skin formed in the treatment chamber and to then feed the grooves with active substance via their opening into this free volume.
